(19) United States
(12) Patent Application Publication
(10) Pub. No.: US 2013/0033999 A1
(43) Pub. Date: Feb. 7, 2013

(54) NODE AND METHODS THEREIN FOR ENHANCED POSITIONING WITH COMPLEMENTARY POSITIONING INFORMATION

(71) Applicants: Iana Siomina, Solna (SE); Torbjorn Wigren, Uppsala (SE)

(72) Inventors: Iana Siomina, Solna (SE); Torbjorn Wigren, Uppsala (SE)

(73) Assignee: TELEFONAKTIEBOLAGET LM ERICSSON (publ), Stockholm (SE)

(21) Appl. No.: 13/517,075

(22) PCT Filed: Feb. 15, 2012
(86) PCT No.: PCT/SE12/50163

§ 371 Date: Jun. 19, 2012

Related U.S. Application Data
(60) Provisional application No. 61/515,609, filed on Aug. 5, 2011.

(51) Int. Cl. H04W 24/00

(52) U.S. Cl. 370/252

(57) ABSTRACT

Example embodiments presented herein are directed towards a positioning node, and method therein, for enhanced user equipment position determination management. Example embodiments are also directed towards a network node, and method therein, for enhanced position determination. The example embodiments may employ the use of complementary positioning information in the management or performance of positioning measurement configurations.

### TECHNICAL FIELD

Example embodiments presented herein are directed towards a positioning node, and methods therein, for enhanced user equipment position determination management.

Example embodiments are also directed towards a radio node, e.g., a user equipment, and methods therein, for enhanced position determination.

### BACKGROUND

### Long Term Evolution Systems

In a typical cellular system, also referred to as a wireless communications network, wireless terminals, also known as mobile stations and/or user equipment units communicate via a Radio Access Network (RAN) to one or more core networks. The wireless terminals may be mobile stations or user equipment units such as mobile telephones also known as “cellular” telephones, and laptops with wireless capability, e.g., mobile termination, and thus may be, for example, portable, pocket, hand-held, computer-comprised, or car-mounted mobile devices which communicate voice and/or data with radio access network.

The radio access network covers a geographical area which is divided into cell areas, with each cell area being served by a base station, e.g., a Radio Base Station (RBS), which in some networks is also called “eNode B” or “Node B” and which in this document also is referred to as a base station. A cell is a geographical area where radio coverage is provided by the radio base station equipment at a base station site. Each cell is identified by an identity within the local radio area, which is broadcast in the cell. The base stations communicate over the air interface operating on radio frequencies with the user equipment units within range of the base stations.

In some versions of the radio access network, several base stations are typically connected, e.g., by landlines or microwave, to a Radio Network Controller (RNC). The radio network controller, also sometimes termed a Base Station Controller (BSC), supervises and coordinates various activities of the plural base stations connected thereto. The radio network controllers are typically connected to one or more core networks.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) access technology. UMTS Terrestrial Radio Access Network (UTRAN) is essentially a radio access network using wideband code division multiple access for user equipment units. The Third Generation Partnership Project (3GPP) has undertaken to evolve further the UTRAN and GSM based radio access network technologies. Long Term Evaluation (LTE) together with Evolved Packet Core (EPC) is the newest addition to the 3GPP family.

An emerging field within the area of wireless communications is positioning or localization. The possibility to determine the position of a mobile device has enabled application developers and wireless network operators to provide location based, and location aware, services. Examples of those are guiding systems, shopping assistance, friend finder, presence services, community and communication services and other information services giving the mobile user information about their surroundings.

In addition to the commercial services, the governments in several countries have put requirements on the network operators to be able to determine the position of an emergency call. For instance, the governmental requirements in the USA (Federal Communications Commission E911) that it must be possible to determine the position of a certain percentage of all emergency calls. The requirements make no difference between indoor and outdoor environment.

### SUMMARY

In current positioning methods, it is the positioning node which decides which position techniques to apply, and the manner in which the selected techniques are applied. Furthermore, current positioning systems do not allow for real-time adjustments of an ongoing positioning measurement or reselection of a positioning method until all of the necessary measurements specific for the earlier selected positioning method are completed. For example, if it is later determined that a current positioning measurement is not ideal, e.g., due to environmental effects, an alternation to the positioning measurement may not be made until the current positioning measurement has finished. In such a scenario, system resources may be wasted as positioning measurement configurations are unnecessarily performed. As such, an objective problem may be formulated as how to provide an efficient means for positioning measurement performance and management.

Example embodiments presented herein relate in general to wireless networks, in particular wireless networks that exercise different positioning methods exploiting radio signal measurements. Thus, at least one object of the example embodiments may be directed towards enhanced positioning method selection and improved positioning with the utilization of multiple radio nodes. This object may be achieved, at least in part, with the use of complementary positioning information.

Some of the example embodiments are directed towards a method, in a positioning node, for enhanced user equipment positioning determination management. The positioning node is comprised in a communications network. The method comprises receiving, from a radio node, complementary positioning information, and configuring positioning measurement instructions based on the received complementary positioning information. The method also comprises sending, to the radio node, the positioning measurement instructions.

Some example embodiments are directed towards a positioning node for enhanced positioning determination management. The positioning node is comprised in a communications network. The node comprises a receiver port configured to receive, from a radio node, complementary positioning information, and an instructions unit configured to provide positioning measurement instructions based on the received complementary positioning information. The positioning node also comprises a transmitter port configured to send the positioning measurement instructions to the radio node.

Some of the example embodiments are directed towards a method, in a radio node, for enhanced position determination. The radio node is comprised in a communications network. The method comprises performing a positioning measurement, and obtaining complementary positioning information based on the positioning measurement configuration. The method also comprises reporting the complementary positioning information to a positioning node.

Some example embodiments are directed towards a radio node for enhanced position determination. The radio node is comprised in a communications network. The radio node comprises a measuring unit configured to perform a positioning measurement and obtain complementary positioning information based on the positioning measurement. The radio node also comprises a transmitter port configured to send the complementary positioning information to a positioning node.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is an illustrative example of a positioning measurement configuration;

FIG. 2 is an illustrative example of LTE positioning architecture;

FIG. 3 is a schematic of a positioning node, according to some of the example embodiments;

FIG. 4 is a schematic of a network node, according to some of the example embodiments;

FIG. 5 is a flow diagram depicting example operations of the positioning node of FIG. 3, according to some of the example embodiments; and

FIG. 6 is a flow diagram depicting example operations of the network node of FIG. 4, according to some of the example embodiments.

### DEFINITIONS

### 3GPP Third Generation Partnership Project

### A-GNSS Assisted Global Navigation Satellite System

### ABS Almost Blank Subframe

### AECID Adaptive Enhanced Cell Identification

### AoA Angle of Arrival

### BSC Base Station Controller

### CID Cell Identification

CRS Cell specific Reference Signals

### CSG Closed Subscriber Group

### DL Downlink

### E-CID Enhanced Cell Identification

### E-SMLC Enhanced Serving Mobile Location Centre

### EPC Evolved Packet Core

### GAD Geographical Area Description

### GMLC Gateway Mobile Location Centre

### GNSS Global Navigation Satellite System

### GPS Global Positioning System

### GPRS General Packet Radio Service

GSM Global System for Mobile communications

### HLR Home Location Register

### HSS Home Subscriber Server

### IPDL Idle Period in Downlink

### LCS Location Services

### LMU Location Measuring Unit

### LOS Line of Sight

### LPP LTE Positioning Protocol

### LPPA LTE Positioning Protocol A

LPPe LTE Positioning Protocol extension

### LTE Long Term Evaluation

### MDT Minimization of Drive Tests

### MME Mobility Management Entity

### MSC Mobile Switching Centre

### O&M Operation and Maintenance

### OMA Open Mobile Alliance

### OTDOA Observed Time Difference of Arrival

### PSAP Public Safety Answering Point

### PGW Packet Data Network Gateway

### PRS Positioning Reference Signals

### RAB Radio Base Station

### RACH Random Access Channel

### RAN Radio Access Network

### RAT Radio Access Technology

### RF Radio Frequency

### RNC Radio Network Controller

### RRC Radio Resource Control

### RSTD Reference Signal Time Difference

### RTT Round Trip Time

Rx-Tx Receive and Transmission difference

### SET SUPL Enabled Terminal

### SGSN Serving GPRS Support Node

### SGW Serving Gateway

### SLP SUPL Location Platform

### SON Self-Optimizing/Organizing Network

### SPC SUPL Positioning Centre

### SRS Sounding Reference Signals

### SUPL Secure User Plane Location

### TA Timing Advance

### TDOA Time Difference of Arrival

### TOA Time of Arrival

### UE User Equipment

### UL Uplink

### UMTS Universal Mobile Telecommunications System

### UTDOA Uplink Time Difference of Arrival

### UTRAN UMTS Terrestrial Radio Access Network

### VMSC Visited Mobile Switching Centre

### WCDMA Wideband Code Division Multiple Access

### DETAILED DESCRIPTION

In the following description, for purposes of explanation and not limitation, specific details are set forth, such as particular components, elements, techniques, etc. in order to provide a thorough understanding of the example embodiments. However, the example embodiments may be practiced in other manners that depart from these specific details. In other instances, detailed descriptions of well-known methods and elements are omitted so as not to obscure the description of the example embodiments.

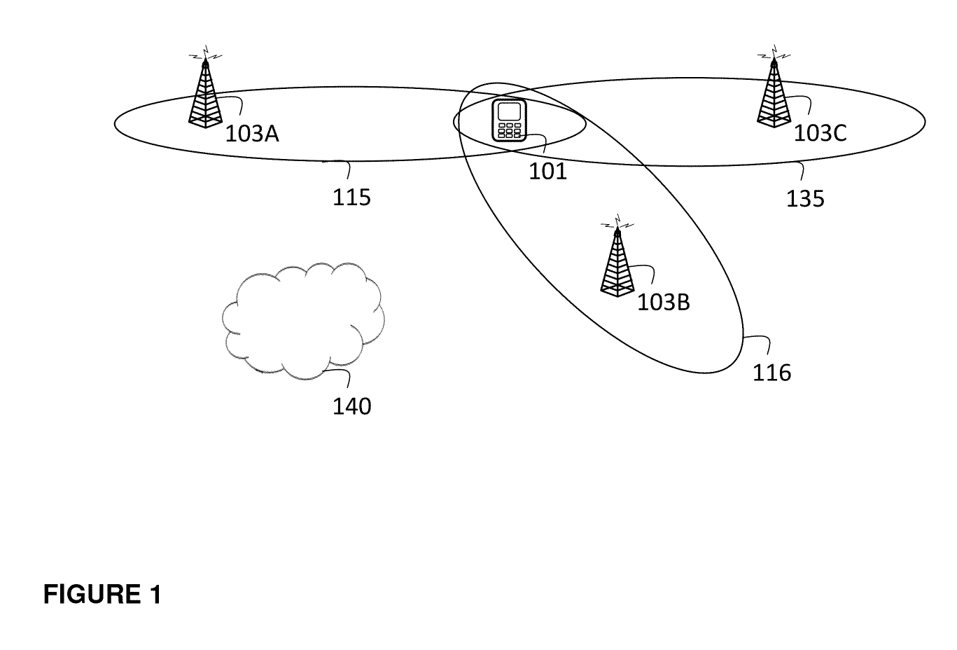

FIG. 1 illustrates a positioning measurement configuration. As shown in FIG. 1, a user equipment 101 may perform positioning measurement configurations with respect to different cells 115, 116 and 135. Any number of base stations 103A, 103B and 103C may be utilized in the positioning measurement configures. The decision of which positioning method is selected, what type of positioning measurement configuration that is to be performed, what measurement configuration shall be used and in which manner the measurements are performed, may be provided by a positioning node 140. Currently, there is no means for dynamically reconfiguring a positioning method or positioning measurement configuration. Specifically, if there is a more suitable, or accurate, positioning measurement configuration than a configuration which is currently being performed, this situation may only be discovered after the current configuration has been completed. As such, system resources may be wasted as unnecessary measurements may be performed.

Thus, example embodiments presented herein are directed towards the use of complementary data in positioning methods. Such complementary data may be used to adjust and/or provide positioning measurement configurations with a more efficient use of system resources.

The remainder of the written description is arranged as follows. First, in order to thoroughly explain the example embodiments herein, the current state of the art and problems therewith will first be identified and discussed in greater detail. The discussion relating to the current state of the art comprises an analysis on the need of integrating positioning methods in the section entitled ‘Integrated Positioning Methods’. Thereafter, a discussion of current positioning methods and an explanation of the different types of methods are provided in the section entitled ‘Positioning Methods’. An explanation of the types of information which may be utilized in the positioning measurements is provided in the section entitled ‘Radio Measurements’. An introduction of LTE positioning architecture is provided in the section entitled ‘Positioning Architecture and Protocols in LTE’. Thereafter, an analysis of the problems in current systems is provided in the section entitled ‘Problems with Existing Systems’.

In the section entitled ‘Complementary Positioning Information’ an explanation is provided on information which may be used, according to the example embodiments, in addition to the information relied upon in current system (as explained in the section entitled ‘Radio Measurements’). Thereafter, examples of how complementary positioning information may be used in the taking of positioning measurements, or in the maintaining of positioning measurement data, in the section entitled ‘Using the Complementary Positioning Information’. Examples of how the complementary data may be obtained and signalled throughout the network are provided in the section entitled ‘Signalling means for obtaining the Complementary Positioning Information’. Finally, an example of a node and operations that may be performed by the node are provided in the sections ‘Example Node Configuration’ and ‘Example Node Operations’, respectively.

### Integrated Positioning Methods

It is known that there is no single positioning method that performs equally well for all radio environments and the need for positioning methods capable of providing a reasonable accuracy in environments where the Global Positioning System (GPS) fails, e.g. indoors or in urban canyons, has become more evident with more than 50% of cell phone calls being placed indoors today. In practice, it has also become evident that network-based positioning only is more coverage-limited than user equipment-assisted positioning due to the maximum power limitation in user equipments, and it is less efficient from the mobile battery saving point of view. Rural deployment of base stations is also quite costly which results in large inter-site distances, larger cells and typically fewer detectable neighbor cells in rural areas, even when positioning is based on non-power controlled transmissions.

Complementing positioning methods is the central positioning concept in LTE. Assisted-Global Navigation Satellite Systems (A-GNSS) and Observed Time Difference Of Arrival (OTDOA) are the major available high-precision location technologies for outdoor and indoor environments, respectively. These may be complemented with a self-learning fingerprinting technology Adaptive Enhanced Cell IDentification denoted AECID. Hybridizing different combinations of at least these technologies may further enhance positioning performance, which makes hybrid positioning an important and powerful positioning technique. Hybridizing methods will be described in greater detail below with respect to the example embodiments.

The standalone positioning techniques are important by themselves but also for their ability to complement each other since every technology has advantages and/or disadvantages in different environments. With various environments and the diverse service demand requiring different accuracy for different applications, only integrated positioning solutions effectively combining different positioning techniques are capable of meeting the wide range of requirements while allowing for efficient use of network and device resources.

The approach of integrating positioning solutions applies not only to different positioning techniques but also to procedure approaches such as user equipment-assisted, user equipment-based and network-based positioning. However, it shall also be understood that generally user equipment-assisted positioning is technically better than user equipment-based positioning, being able to exploit the user equipment measurements and the available knowledge about the radio environment accumulated in the network, while keeping the user equipment complexity low. Similarly, user equipment-assisted positioning is technically better than standalone network-based positioning relying only on network measurements and the network knowledge but being constrained by the uplink power limitation and no possibility to benefit from the measurements at the actual location of the user equipment.

One possible approach to enhance positioning method selection is to exploit the collected historical performance of different positioning methods in the area. The approach may, however, further benefit from more dynamic information such as provided by the complementary ranging information, user equipment speed and radio property measurements like delay spread and Doppler frequency described by some of the example embodiments presented herein.

Furthermore, the integrated positioning solutions do not imply only the system's ability to support multiple positioning methods, but also by their ability to cooperate, which is also addressed by some of the example embodiments provided herein by enabling to incorporate Cell ID based and proximity-like positioning methods into more sophisticated positioning methods which may be beneficial particularly in heterogeneous network deployments.

### Positioning Methods

Cell ID and E-CID

With regards to Cell Identification (CID), given the cell ID of the serving cell, the user equipment position is associated with the cell coverage area which may be described, for example, by a pre-stored polygon, where the cell boundary is modeled by a set of non-intersecting polygon segments connecting all the corners.

With regards to Enhanced CID (E-CID), these methods exploit four sources of position information: (1) the CID and the corresponding geographical description of the serving cell, (2) the round trip time (RTT) with respect to the serving cell, measured for example by means of Timing Advance (TA) and/or receive-transmit time difference measured at either the user equipment and base station side, (3) the CIDs and the corresponding signal measurements of the cells (up to 32 cells in LTE, including the serving cell), as well as (4) Angle Of Arrival (AoA) measurements. The three most common E-CID techniques include: (1) CID+RTT, (2) CID+signal strength and (3) AoA+RTT. The positioning result of CID+RTT is typically an ellipsoid arc describing the intersection between a polygon and circle corresponding to RTT. A typical result format of the signal-strength based E-CID positioning is a polygon since the signal strength is subject, e.g., to fading effects and therefore often does not scale exactly with the distance. A typical result of AoA+RTT positioning is an ellipsoid arc which is an intersection of a sector limited by AoA measurements and a circle from the RTT-like measurements.

Fingerprinting Positioning

Another approach is provided by so called fingerprinting positioning. Fingerprinting positioning algorithms operate by creating a radio fingerprint for each point of a fine coordinate grid that covers the Radio Access Network (RAN). The radio fingerprint may, for example, comprise the cell IDs that are detected by the user equipment, in each grid point. The radio fingerprint may also comprise quantized path loss or signal strength measurements, with respect to multiple base stations, performed by the user equipment, in each grid point. It should be appreciated that an associated ID of the base station may also be needed. Radio fingerprints may also comprise quantized Timing Advance (TA), in each grid point, where an associated ID of the base station may also be needed. Radio fingerprints may further comprise quantized Angle of Arrival (AoA) information.

Whenever a position request arrives to the positioning node 140, a radio fingerprint is first measured, after which the corresponding grid point is looked up and reported. This may be performed under the assumption that the point is unique.

The use of radio fingerprints may utilize reference positions, or a database of reference positions. The database of fingerprinted positions may be generated in several ways. A first alternative would be to perform an extensive surveying operation that performs fingerprinting radio measurements repeatedly for all coordinate grid points of the RAN.

Disadvantages of this approach include the required surveying becoming substantial for small cellular networks. Furthermore, the radio fingerprints are in some instants, e.g., signal strength and pathloss, sensitive to the orientation of the user equipment, a fact that is particularly troublesome for handheld user equipments. For fine grids, the accuracies of the fingerprinted positions therefore become highly uncertain. This is unfortunately seldom reflected in the accuracy of the reported geographical result.

Another approach, applied e.g., in Adaptive Enhanced Cell ID entity (AECID) positioning, is to replace the fine grid by high precision position measurements of opportunity, and to provide fingerprinting radio measurements for said points. This avoids the above drawbacks. However, algorithms for clustering of high precision position measurements of opportunity need to be defined. Furthermore, algorithms for computation of geographical descriptions of the clusters need to be defined.

OTDOA

The OTDOA positioning method makes use of the measured timing of downlink signals received from multiple radio nodes at the user equipment. With OTDOA, a user equipment measures the timing differences for downlink reference signals received from multiple distinct locations. For each measured neighbor cell, the user equipment may measure Reference Signal Time Difference (RSTD) which is the relative timing difference between a neighbor cell and a reference cell. The user equipment position estimate may then be found as the intersection of hyperbolas corresponding to the measured RSTDs. At least three measurements from geographically dispersed base stations with a good geometry are needed to solve for two coordinates of the user equipment and the receiver clock bias. In order to solve for position, precise knowledge of the transmitter locations and transmit timing offset is needed.

To enable positioning in LTE and facilitate positioning measurements of a proper quality and for a sufficient number of distinct locations, new physical signals dedicated for positioning (e.g., positioning reference signals (PRS) as described in 3GPP TS 36.211) have been introduced and low-interference positioning subframes have been specified in 3GPP, although OTDOA is not limited to PRS only and may be performed on other signals as well, e.g., Cell specific Reference Signals (CRS).

UTDOA

In Uplink Time Difference of Arrival (UTOA), the uplink positioning makes use of transmitted uplink signals from the user equipment, where the timing of such signals are measured at multiple locations by radio nodes, e.g., by Location Measurement Units (LMUs) or base stations. The radio node measures the timing of the received signals using assistance data received from the positioning node, and the resulting measurements are used to estimate the location of the user equipment. Position calculation is similar to that with OTDOA.

GNSS and A-GNSS

Global Navigation Satellite System (GNSS) is a generic name for satellite-based positioning systems with global coverage. Examples of GNSS systems include the US Global Positioning System (GPS), the European Galileo, the Russian Glonass, and the Chinese Compass. GNSS positioning requires GNSS-capable receivers. With an Assisted Global Navigation Satellite System (A-GNSS), the receivers receive the assistance data from the network. The positioning calculation is based on multi-lateration with Time Of Arrival (TOA)-like measurements.

### Radio Measurements

Some of the positioning measurements described above and the example embodiments described herein utilize radio measurements. Brief examples of such radio measurements are provided below.

Radio Signal Strength and Quality Measurements Power-based radio signal measurements such as signal strength or quality may be used for positioning to derive the distance, e.g., based on the pathloss estimation, or as Radio Frequency (RF) fingerprints. These measurements may be performed by the user equipment or radio nodes.

Timing Measurements

Example timing measurements are time of arrival, round trip time, time difference of arrival, receive and transmission differences (Rx-Tx), and timing advance. Timing measurements in general allow for obtaining greater accuracy in distance information compared to distance estimation based on radio signal strength/pathloss measurements due to the fading fluctuations of the latter. Timing measurements are commonly used for positioning, although they may serve more general network purposes as well. Timing measurements may be performed by user equipment or the radio node or both. The latter alternative applies for two-directional measurements such as RTT.

AoAMeasurement

The angle of arrival (AoA) measurement standardized for LTE is defined as the estimated angle of a user equipment with respect to a reference direction which is the geographical north, positive in the clockwise direction. This measurement may be performed by the base station or user equipment.

Delay Spread

Radio propagation may be thought of as rays of radiation emitted from a transmit antenna. These rays propagate in straight lines in various directions and with various powers, as manifested by an antenna diagram. When obstacles are encountered the rays are scattered. The rays that arrive at a receiver antenna therefore have traveled different ways and are impinging on the receiver antenna(s) from different directions. Since the traveled distance is not equal among rays, i.e., multipath propagation persists, the rays also arrive at different times. In this way the response to a transmission of a pulse is spread out in time. This spreading in time is usually denoted delay spread. It may be measured and defined in many ways; however, for this discussion it is important to understand that a high delay spread is an indication of much multi-path propagation, and radiation that impinges on the receiver antenna(s) from different directions.

Doppler

A Doppler spectrum or Doppler effect is a consequence of the user equipment moving. To understand its effect on positioning it is necessary to understand that a radio signal fades. So called fast fading is a result of the random addition of radio waves impinging at the receiver antenna from different directions. This may be thought of as generating a power variation that is a function of the user equipment location. Typically, the fading power correlation distance is a fraction of the carrier wavelength and it is relatively stationary in space. Standard radio propagation calculations show that such fast fading sometimes follows a Rayleigh distribution.

As compared to a stationary user equipment, the moving user equipment experiences a movement in this power fading field. This manifests itself as a variation of the received power (unless fast power control is applied), causing a corresponding random variation of the received power. This is commonly modeled by a Doppler spectrum.

Typically, very fast movements cause a so fast variation that averaging over a radio frame may reduce the effect of fading. Very slow movement may also normally be handled by slow power control. Intermediate movement is sometimes more difficult.

The Doppler typically affects positioning measurement by sometimes making power-based measurements inaccurate. Furthermore, Doppler also affects positioning by making the SNR too poor for other measurements that are performed with little time integration, thereby causing a reduced inaccuracy.

### Positioning Architecture and Protocols in LTE

The three key network elements in an LTE positioning architecture are a Location Services (LCS) Client, a LCS target and a LCS Server. The LCS Server is a physical or logical entity managing positioning for a LCS target device by collecting measurements and other location information, assisting the user equipment in measurements when necessary, and estimating the LCS target location. A LCS Client is a software and/or hardware entity that interacts with a LCS Server for the purpose of obtaining location information for one or more LCS targets, i.e., the entities being positioned. LCS Client may reside in a network node, in radio node or in a user equipment. LCS Clients may also reside in the LCS targets. An LCS Client sends a request to LCS Server to obtain location information, and LCS Server processes and serves the received requests and sends the positioning result and optionally a velocity estimate to the LCS Client. A positioning request may be originated from the user equipment or the network.

DL Positioning

Two positioning protocols operating via the radio network exist in LTE, LTE Positioning Protocol (LPP) and LTE Positioning Protocol A (LPPa). The LPP is a point-to-point protocol between a LCS Server and a LCS target device, used in order to position the target device. LPP may be used both in the user and control plane, and multiple LPP procedures are allowed in series and/or in parallel thereby reducing latency. LPPa is a protocol between base station and LCS Server specified only for control-plane positioning procedures, although it still may assist user-plane positioning by querying base stations for information and base station measurements. Secure User Plane Location (SUPL) protocols may be used as a transport for LPP in the user plane. In the user plane with SUPL, a user equipment is typically referred to as SUPL Enabled Terminal (SET), the LCS platform is typically referred to as SUPL Location Platform (SLP). An LPP extension (LPPe) is also defined by the Open Mobile Alliance (OMA) and may be used to extend the LPP signaling, e.g. to provide more extended position reports or provide more assistance data, e.g., to better support measurement of a certain method or to support more methods and Radio Access Technologies (RATs). Other extensions may potentially be supported by LPP in the future.

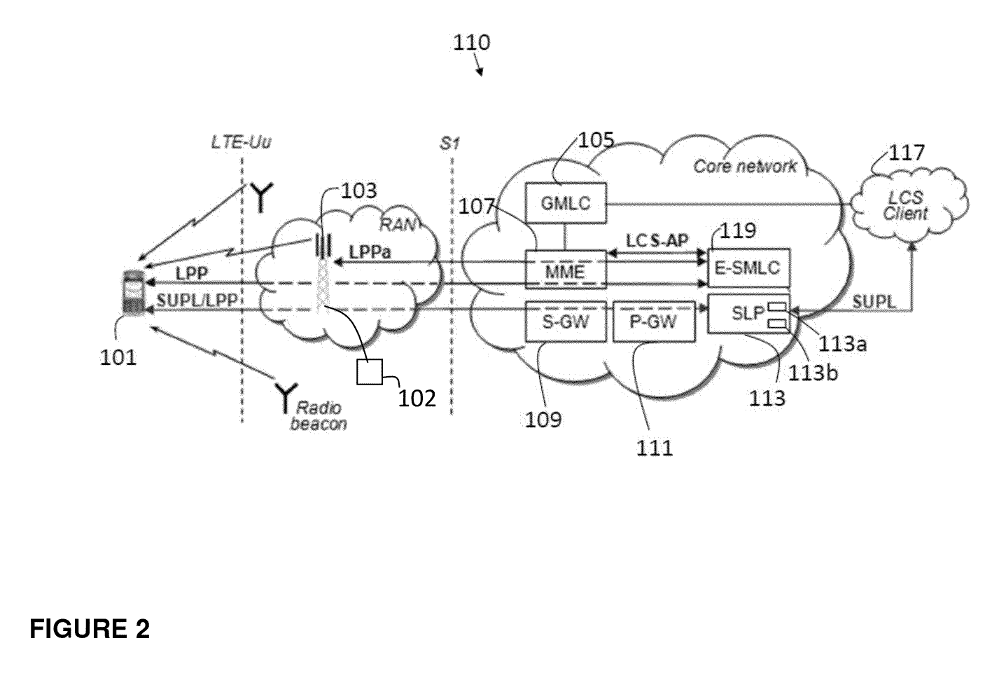

FIG. 2 illustrates positioning architecture in an LTE system. The positioning architecture may comprise a user equipment 101 which may be configured to perform positioning measurements. The user equipment 101 may be in communication with a base station 103. The base station 103 may be in communication with a core network comprising a Serving Gateway (SGW) 109, a Packet Data Network Gateway (PGW) 111 and a Mobility Management Entity (MME) 107. The base station 103 may also be in communication with a Location Measurement Unit (LMU) 102 which may assist in preforming measurements. The core network may also comprise a number of positioning nodes, for example, a Gateway Mobile Location Centre (GMLC) 105, an Enhanced Serving Mobile Location Centre (E-SMLC) 115 and/or a Secure User Plane Location Platform (SLP) 113. SLP 113 may comprise two components, SPC 113b and SLC 113a, which may also reside in different nodes. In an example implementation, SPC 113b has a proprietary interface with E-SMLC 119, and Lip interface with SLC 113a, and the SLC part of SLP 113 communicates with P-GW (Packet Data Network Gateway) and External LCS Client.

The GMLC 105 may be used to request routing information from the Home Location register (HLR) or Home Subscriber Server (HSS). The GMLC 105 may also be used to positioning requests to either the Visited Mobile Switching Centre (VMSC), Serving GPRS Support Node (SGSN) or Mobile Switching Centre (MSC) Server and receive final location estimates from the corresponding entity. The E-SMLC 115 may communicate with the user equipment 101 for location services and assistance data delivery using an LPP protocol. The E-SMLC 115 may also communication with the base station 103 of assistance data purposes using an LPPa protocol. The SLP 113 may be responsible for coordination and administrative functions to provide location services. The SLP 113 may also be responsible for positioning functions. The SLP 113 is a positioning node in the user plane.

Additional positioning architecture elements may also be deployed to further enhance performance of specific positioning methods. For example, deploying radio beacons is a cost-efficient solution which may significantly improve positioning performance indoors and also outdoors by allowing more accurate positioning, for example, with proximity location techniques. The described protocols are so far defined to support mainly DL positioning.

UL Positioning

The architecture for UL positioning, or network-based positioning, is currently being discussed in 3GPP at a high level, i.e., without many details. It is assumed that UTDOA measurements are being performed by LMUs, though measurements by base stations are not precluded, and the measurements are based on Sounding Reference Signals (SRS). The following three approaches for communications between positioning node and LMU are currently being discussed: (1) LPPa-based for both base station-integrated and standalone LMUs, (2) transparent overlay for both base station-integrated and standalone LMUs using a new interface (transparent to base station; the interface may be called “SLm”) between E-SMLC and LMUs, and (3) a hybrid LPPa-based approach for base station-integrated LMUs and transparent overlay for standalone LMUs. Independently of the three approaches, LPPa is likely to be enhanced for communications between base station and E-SMLC necessary to support UTDOA, e.g., related to configuring SRS to enable UTDOA measurements.

Positioning Result

A positioning result is a result of processing of obtained measurements, including Cell IDs, power levels, received signal strengths, etc., and it may be exchanged among nodes in one of the pre-defined formats. The signaled positioning result is represented in a pre-defined format corresponding to one of the seven Geographical Area Description (GAD) shapes.

The positioning result may be signaled between: (1) the LCS target and LCS server, e.g., over LPP protocol; (2) positioning servers (e.g., E-SMLC and SLP), over standardized or proprietary interfaces; (3) positioning server and other network nodes (e.g., E-SMLC and MME/MSC/GMLC/O&M/SON); and (4) positioning node and LCS Client (e.g., between E-SMLC and PSAP or between SLP and External LCS Client or between E-SMLC and user equipment).

### Overview of the Example Embodiments

At least the following example problems have been identified with prior art. First, Cell ID based and proximity-like positioning methods may outperform other positioning methods in small cells, i.e., the best positioning method depends on how far the user equipment is from radio nodes with known locations. However, the node that selects the method, e.g., E-SMLC in LTE, may be not aware of the user equipment distance with respect to any radio node. Furthermore, a power-based measurement is not always well reflecting of the distance. It should also be appreciated that radio nodes (e.g., associated with the serving cell) may have the range information but may not decide the positioning method (e.g., the choice between CID or UTDOA positioning).

Another example problem is that AoA based positioning and positioning methods that combine other information with AoA may be beneficial in certain areas. However, it is well known that in regions with a lot multipath, e.g., in metropolis areas, the performance deteriorates significantly due to the fact that the signal energy impinges on the receiver antenna from directions other than from the direction to the user equipment (in the UL example). Furthermore, there is no signaling of indicators based on measurements over existing positioning protocols that indicate when this becomes a problem or indicating the amount of the impact.

A further example of a problem is fingerprinting, for example, AECID and other positioning methods that exploit power measurements are known to provide benefits in certain situations. However, user equipment movement may cause Doppler effects that impair the accuracy of the power measurements, causing poor data to enter AECID databases, or causing inaccurate fingerprinting and AECID positioning results. Furthermore, there is no signaling of indicators based on measurements of Doppler over existing positioning protocols that indicate when a reduced power/pathloss measurement performance may be expected or indicate the amount of the possible reduction. Also, there is no signaling means to inform the positioning node about the user equipment speed to facilitate positioning method selection.

Another example problem is that there is no possibility to re-decide the positioning method (e.g. perform Cell ID method) based on the received measurements which are not Cell ID measurements. With OTDOA, E-SMLC does not receive sufficient and reliable information, e.g., the user equipment would not report the TA or ToA when the requested measurement is a Reference Signal Time Difference (RSTD) measurement with respect to a reference cell. In fact, no measurement is reported for the reference cell with OTDOA. The measurements reported with UTDOA are currently not defined by the standard. There is currently no logic in the E-SMLC to re-decide the positioning method and use the received measurements for other positioning methods than the requested one. Furthermore, for some positioning methods, multiple radio nodes have to be involved to enable positioning, and the positioning node being responsible for the assistance data may need to select the assisting radio nodes with a good location with respect to the measuring point (e.g., user equipment with OTDOA and radio node with UTDOA).

The list of the involved radio nodes depends on the hearability of the signals to be measured. The hearability range of a signal depends on the propagation distance and the environment but also on the transmit power. The transmit power of power-controlled transmissions is determined with respect to the pathloss with the serving cell, e.g., user equipments closer to the serving cell transmit at a lower power although they are farther away from neighbor radio nodes which may also need to perform measurements on the user equipment transmissions. For DL, different nodes may have different transmit power, e.g., the standardized power classes for radio base stations define the transmit power from 20 dBm per antenna port to 46 dBm, i.e., the received signal strength for the same pathloss may be 26 dB in this example or the pathloss difference for the same received signal strength may be 26 dB. Neither the distance to the serving cell nor the distance to neighbor radio nodes involved in positioning measurements may be known to the positioning node when deciding the list of the involved radio nodes.

Thus, example embodiments presented herein may be utilized to solve the above mentioned problems. Some of the example embodiments may be directed towards methods of obtaining complementary ranging information, delay spread information, Doppler information, and/or speed information. Some example embodiments may be directed towards signalling means for communicating the complementary ranging information, delay spread information, Doppler information, and/or speed information. Some example embodiments may be directed towards methods for using complementary ranging information, delay spread, Doppler information, and/or the speed information. Such information may be used for positioning method selection/re-selection, and/or managing a list of assisting radio nodes in the assistance data to facilitate positioning measurements. Below different aspects of the example embodiments will be discussed in greater detail according to the appropriate sub-heading.

### Complementary Positioning Information

In order to remedy the above mentioned problems the example embodiments described herein utilize complementary positioning information. Complementary positioning information comprises any one or any combination of: complementary ranging information, delay spread information and Doppler information or any multi-path related information, speed information, which are further described in more detail. In some of the example embodiments, the complementary positioning information may also comprise other information characterizing a frequency spectrum as seen at the receiver and/or transmitter.

Complementary Ranging Information

The complementary ranging information is the information provided, e.g., for any of: a complement to requested measurements that are native to the selected positioning method, also referred herein to as baseline method, to facilitate the positioning method selection/reselection, of for managing assistance data.

The complementary ranging information relates to a distance (range) between at least one transmitter and one receiver and may be, although not limited to, any one of: estimated absolute distance, estimated relative distance, and/or an absolute timing measurement, e.g., Timing Advance, UE Rx-Tx, base station Rx-Tx, TOA, TDOA, RTT, or similar. The absolute timing measurement is different from the baseline method measurement if the measurement is provided together with the baseline method measurements. The complementary ranging information also comprises relative timing, an absolute received signal strength measurement, relative received signal strength, and/or an indication of a distance or proximity, e.g., a binary indicator may be used to indicate distance within or outside a range.

The relative ranging information, e.g., relative distance or relative timing, may be provided with respect to a reference transmitter or receiver, which, in some embodiments, may be associated with a serving or primary cell. In some example embodiments, the relative ranging information may be provided with respect to a reference measure, e.g., a reference distance or reference timing, respectively. The relative measures may be the differences or ratios, and may be, e.g., in linear or logarithmic scale.

Furthermore, the ranging information may be obtained for multiple transmitters and/or multiple receivers. Some examples of a transmitter are a user equipment (e.g., for UL positioning) and a radio node (e.g., for DL positioning). Some examples of a receiver are a radio node (e.g., for UL positioning) and a user equipment (e.g., for DL positioning). Distributed multiple transmit and/or receive antennas may be considered as multiple transmitters or receivers, respectively. Without limiting the scope of the example embodiments, the complementary ranging information may be obtained for any cell or any transmit and/or receive node, which may or may not create its own cell.

A ranging measure from the complementary ranging information may be used to evaluate the distance, e.g., by comparing to a threshold, which may be a user programmable threshold. A positioning method enhanced with the complementary ranging information is further referred to as the baseline method. Some examples of the baseline methods are OTDOA, UTDOA, any TDOA-like method, but it may in principle be any positioning method, e.g., a Cell ID based method, AECID or any other, especially with carrier aggregation when the multiple serving cells may exist.

The benefit with the complementary ranging information is more efficient positioning and better resource utilization. It may be faster to obtain than all the baseline measurements and it may reduce the probability of calculations and measurements that lead to worse accuracy with more “expensive” methods.

The complementary cell ranging measurements may be performed based on DL or UL physical signals (e.g. in LTE: CRS, synchronization signals, Sounding Reference Signals, Positioning Reference Signals, other reference signals, etc.) and/or channels (e.g., Random Access Channel (RACH)). The measurements may be intra-frequency, inter-frequency, or inter-RAT.

Delay Spread Information

The delay spread information is the information related to the amount of multi-path between at least one transmitter and one receiver. In some of the example embodiments presented herein, it may be provided in a number of ways. For example, as a complement to requested measurements that are native to the selected positioning method (also referred herein to as a baseline method, an example is that delay spread may be used as a part of the fingerprint in fingerprinting positioning and in AECID). The information may also be used to facilitate the positioning method selection.

The delay spread information may be provided with respect to a reference transmitter or receiver, which, in some example embodiments, may be associated with a serving or primary cell. In some example embodiments, the delay spread information may be provided with respect to a reference measure. The relative measures may be the differences or the ratios, and may be, e.g., in linear or logarithmic scale.

Further, the delay spread information may be obtained for multiple transmitters and/or multiple receivers. Some examples of a transmitter are a user equipment (e.g., for UL positioning) and a radio node (e.g., for DL positioning). Some examples of a receiver are a radio node (e.g., for UL positioning) and a user equipment (e.g., for DL positioning). Distributed multiple transmit and/or receive antennas may be considered as multiple transmitters or receivers, respectively. Without limiting the scope of the example embodiments, the delay spread information may be obtained for any cell or any transmit and/or receive node, which may or may not create its own cell.

The delay spread information may be used to evaluate the amount of multi-path and non-line of sight (non-LOS) radio propagation, e.g., by comparing to a threshold. The delay spread information may also comprise a measure characterized by one of the pre-defined levels or indicators, e.g., “high”/“low” or provided as an environment characteristic, e.g., “rich multi-path environment”, etc.

A positioning method enhanced with the delay spread information is further referred to as the baseline method. Some examples of the baseline methods include E-CID, UTDOA, OTDOA, fingerprinting positioning and AECID. One benefit with the delay spread information is that application of AoA based positioning methods may be controlled in a more efficient way. Another benefit is that delay spread information may be made a part of the fingerprint in fingerprinting positioning and AECID.

The delay spread measurements may be performed based on DL or UL physical signals (e.g. in LTE: CRS, synchronization signals, Sounding Reference Signals, Positioning Reference Signals, other reference signals, etc.) and/or channels (e.g., RACH). The measurements may be intra-frequency, inter-frequency, or inter-RAT. The delay spread information may also be aggregated (e.g. into one fingerprint) to reflect multiple cells.

Doppler Information and Speed

The Doppler information is the information provided any number of ways. For example, as a complement to requested measurements that are native to the selected positioning method (also referred herein to as baseline method, an example is that Doppler may be used as a part of the fingerprint in fingerprinting positioning and in AECID marking e.g. freeways with fast user equipment movement). The information may also be provided to facilitate the positioning method selection.

The Doppler information describes the dominating frequency of the Doppler spectrum, e.g., by means of Doppler shift. It typically depends on frequency and relative velocity of the transmitter and receiver. The Doppler information may be provided with respect to a reference transmitter or receiver, which, in some example embodiments, may be associated with a serving or primary cell. In some example embodiments, the Doppler information may be provided with respect to a reference measure. The relative measures may be differences or ratios, and may be, e.g., in linear or logarithmic scale.

Furthermore, the Doppler information may be obtained for multiple transmitters and/or multiple receivers. Some examples of a transmitter are a user equipment (e.g., for UL positioning) and a radio node (e.g., for DL positioning). Some examples of a receiver are a radio node (e.g., for UL positioning) and a user equipment (e.g., for DL positioning). Distributed multiple transmit and/or receive antennas may be considered as multiple transmitters or receivers, respectively. Without limiting the scope of the example embodiments, the Doppler information may be obtained for any cell or any transmit and/or receive node, which may or may not create its own cell.

The Doppler information may also be provided as one of the pre-defined levels or indicators, e.g., “high”/“medium”/“low” or provided as an environment characteristic, e.g., “high velocity”, etc. Furthermore, speed information may also be provided, e.g., as a part of Doppler information or separately from it. The speed information may be derived using the Doppler measurements or may be known or available from other sources. The Doppler and/or speed information may be used to evaluate the accuracy of power measurements as well as other measurements that are not using long time integration, e.g., by comparing to a threshold, which may be a user programmable threshold.

A positioning method enhanced with the Doppler and/or speed information is further referred to as the baseline method. Some examples of the baseline methods include E-CID, OTDOA, UTDOA, fingerprinting positioning and AECID. One benefit with the Doppler and/or speed information is that the application of power based positioning methods may be controlled in a more efficient way. Another benefit is that Doppler information may be made a part of the fingerprint in fingerprinting positioning and AECID.

The Doppler measurements may be performed based on DL or UL physical signals (e.g. in LTE: CRS, synchronization signals, Sounding Reference Signals, Positioning Reference Signals, other reference signals, etc.) and/or channels (e.g., RACH). The measurements may be intra-frequency, inter-frequency, or inter-RAT.

### Using the Complementary Positioning Information

The methods of using the complementary positioning information may be implemented in a network node, e.g., a positioning node, a gateway node, a node serving as an interface between a radio node and positioning node, or any node communicating with positioning node, and/or a radio node, e.g., base station, LMU, RNC, and/or user equipment. Note that complementary ranging information, delay spread, speed information, and Doppler may also be combined in any way.

Some example methods for using complementary positioning information may be for enhancing positioning method selection/re-selection, hybridizing the complementary measurements and baseline measurements, managing the list of assisting radio nodes, and/or optimizing the configuration of signals to be measured and coordinating the interference. These examples are described in more detail below.

Enhancing Positioning Method Selection/Re-Selection

The positioning node may obtain the complementary positioning information and selects a positioning method. For example, a Cell ID based, e.g., CID, E-CID, or AECID, or civic address or proximity-like positioning method may be selected when the complementary ranging information indicates a short distance to at least one of the cells, and e.g., when a complementary ranging measure is below a user programmable threshold. This may be particularly important for power-controlled transmissions. Multiple thresholds may be defined, e.g., different thresholds may be used under different conditions. Different thresholds may also be associated with different positioning methods, and the thresholds may be related to the statistical average or expected accuracy of the positioning method.

An example of enhancing positioning method selection/re-selection may comprise the complementary ranging information being obtained prior to the method selection, e.g., with a positioning request or assistance data request. The complementary ranging information may also or alternatively be obtained after selecting a positioning method, but used for method reselection during executing the selected method, e.g., with assistance data request or with measurement reports. If there is no need to continue with the native measurements for the selected method, the baseline method measurements may be aborted, e.g., by sending an abort message.

In some example embodiments, a Cell ID based or proximity-like positioning method is a baseline method. Example complementary ranging information may comprise TDOA, e.g., a relative timing of the two cells, which is typically not a native measurement for this baseline method. If the complementary ranging information indicates a relatively large range to the serving cell compared to another cell (e.g., when a user equipment is located at a cell border and the neighbour cell has even smaller coverage being a femto cell or an overloaded cell not being able to accept the user equipment connection), then the Cell ID based or proximity-like positioning may be performed with respect to the closest cell.

In some example embodiments, the positioning node may obtain the delay spread information and select a positioning method. For example, AoA based positioning methods may be selected when the delay spread information indicates little multipath. Multiple user programmable thresholds may be defined, e.g., different thresholds may be used under different conditions. Different thresholds may also be associated with different positioning methods, and the thresholds may be related to the statistical average or expected accuracy of the positioning method.

In some example embodiments, the delay spread information may be obtained prior to method selection, e.g., with a positioning request or assistance data request. The delay spread information may also be obtained after selecting a positioning method, but used for method reselection during executing the selected method, e.g., with assistance data request or with measurement reports. If there is no need to continue with the native measurements for the selected method, the baseline method measurements may be aborted, e.g., by sending an abort message. In some example embodiments, a fingerprinting positioning method or AECID is a baseline method.

In some example embodiments, the positioning node may obtain the Doppler information and select a positioning method. For example, fingerprinting methods or the AECID method may be selected when the Doppler information indicates that the power/pathloss measurement is accurate. Multiple user programmable thresholds may be defined, e.g., different thresholds may be used under different conditions. Different thresholds may also be associated with different positioning methods, and the thresholds may be related to the statistical average or expected accuracy of the positioning method.

In some of the example embodiments, the Doppler information may be obtained prior method selection, e.g., with a positioning request or assistance data request. The Doppler information may also be obtained after selecting a positioning method, but used for method reselection during executing the selected method, e.g., with assistance data request or with measurement reports. If there is no need to continue with the native measurements for the selected method, the baseline method measurements may be aborted, e.g., by sending an abort message. In some example embodiments, a fingerprinting positioning method or AECID is a baseline method.

Hybridizing the Complementary Positioning Information with the Baseline Method

In some example embodiments, it may be not necessary to explicitly change the positioning method, even when the baseline measurements have been initiated and the complementary ranging information have indicated a close location to one or more radio node with a known location. Instead, the complementary ranging information may be hybridized with the baseline method measurements or with the baseline method positioning result to improve the positioning accuracy, e.g., reduce the uncertainty or correct the location estimate.

It should be appreciated that the example embodiments are not limited to the complementary ranging information, but may apply for any form of the complementary positioning information described herein. If fingerprinting positioning or AECID is prepared for use of said information, then the hybridization may also be automatic for delay spread and Doppler information.

Selecting Assisting Radio Nodes with OTDOA

Some of the example embodiments may comprise the use of complementary positioning information for selecting assisting nodes. With OTDOA, the assistance data is provided to the user equipment by the positioning node, e.g., E-SMLC in LTE.

For example, with user equipment selected assisting nodes; the user equipment may select a subset of radio nodes, for a set of nodes, to be measured. The set of nodes (or associated cells) may comprise cells received by the user equipment in the assistance data in one or more messages and/or cells measured by the user equipment earlier. The user equipment may obtain the complementary ranging information and based on this information, select a subset of radio nodes for which a complementary ranging measure for each of the selected node is below a user programmable threshold, i.e., the closest cells with a certain range. Multiple thresholds may be used to define multiple ranges. The complementary range information obtained by the user equipment concerns the user equipment to be positioned (receiver) and the radio nodes (transmitters).

Another example is where the positioning node is the selected assisting node. Similarly, from a set of nodes, the positioning node selects a subset of radio nodes, e.g., at least N best of which are comprised in the OTDOA assistance data sent to the user equipment. The complementary range information obtained by the positioning node concerns the user equipment to be positioned (receiver) and the radio nodes (transmitters).

Doppler information or speed may also be used in the example provided above. For example, based on this information, it may be easier to choose the right layer of the assisting nodes, e.g., choosing a macro layer base stations for outdoor-like environment or fast moving user equipments, or choosing radio nodes with smaller coverage if the user equipment is slow moving or is relatively static. Delay spread information may also be used here.

Selecting Assisting Radio Nodes with UTDOA

With UTDOA, a network node, e.g., positioning node, may select a set of cooperating radio nodes and/or LMUs. For example, a positioning node may obtain the complementary ranging information which concerns the user equipment to be positioned (transmitter) and the radio nodes (receivers) and select a subset of radio nodes based on the complementary ranging information, e.g., by comparing the a complementary ranging measure for each selected node to a user programmable threshold. Multiple thresholds may be defined and applied, e.g., in an increasing order until N nodes may be selected.

In another example, the serving cell of the user equipment to be positioned may obtain the complementary ranging information and select a subset of radio nodes using this information. The subset of radio nodes may be communicated to the positioning node. Doppler information, speed information, and/or delay spread information may also be used in the examples provided above.

Selecting Assisting Radio Nodes with AoA Based Positioning—Pure AoA and AoA Combined with Other Information

With AoA based positioning, AoA measurements from several radio nodes may need to be combined. The positioning node may then select the assisting nodes based on received delay spread information from said nodes. Similarly, from a set of nodes, the positioning node selects a subset of radio nodes, at least N best of which are used to set up AoA based positioning. The complementary positioning information obtained by the positioning node concerns the user equipment to be positioned (transmitter) and the radio nodes (receivers) for UL AoA or the other way around for DL AoA. As an alternative, the AoA measurements from all assisting nodes may be optimally statistically combined using Doppler information as a measurement accuracy indicator. The complementary ranging information may also be used in the examples provided above.

Selecting Assisting Radio Nodes with AECID and Fingerprinting Positioning

With fingerprinting of AECID positioning, power/pathloss measurements from several radio nodes may need to be combined. The positioning node may then select the assisting nodes based on received Doppler information from said nodes. Similarly, from a set of nodes, the positioning node may select a subset of radio nodes, at least N best of which may be used to set up fingerprinting or AECID based positioning. The Doppler information obtained by the positioning node concerns the user equipment to be positioned (transmitter) and the radio nodes (receivers), when UL is considered, and vice versa for DL. As an alternative, the power measurements from all assisting nodes may be optimally statistically combined using Doppler information as a measurement accuracy indicator. The complementary ranging information may also be used here.

Optimizing the Configuration of Signals to be Measured

Based on the complementary ranging information, Doppler, delay spread, or speed or any combination thereof, a network node (e.g., positioning node, radio node) may utilize the complementary ranging information in order to enhance positioning measurements. The information may be used to identify whether interference coordination for the signals to be measured is necessary and if so ensure: (a) avoiding measuring weak signals during high interference, (b) suppressing transmissions of the strong interferer during measurements of potentially week signals (e.g. configure IPDL, PRS muting, reduced power transmissions, restricted measurement subframes, reduced-activity or ABS time periods), and/or (c) ensure transmission of the signals on orthogonal resources, e.g. for UL positioning by configuring SRS accordingly.

For example, when a user equipment located near (within a range of) the serving cell and the serving cell signal is interfering with a signal of a remote radio node to be measured, muting of the serving-cell signals or configuring low-interference time periods in the serving cell may be beneficial. In another example, a user equipment at a cell edge of a large serving cell may transmit at high power and strongly interfere to a closely located radio node performing UL measurements. In both examples above, the estimated absolute range with respect to the serving cell or the relative distance or relative signal strength of the two cells may be useful as the complementary ranging information in this case.

Some of the example embodiments may comprise the ability to identify whether power boosting on the measured signals may improve positioning performance, e.g., by applying a non-zero power offset or increasing the power offset for the transmissions based on which positioning measurements are to be performed, e.g., SRS for UTDOA or PRS for OTDOA. For example, for a user equipment closely located to the serving node, and thus power-controlled with respect to the serving cell, may still be measured by other radio nodes and therefore boost its transmission power of the signals to be measured, this should typically improve the signal hearability.

In some example embodiments, power boosting in the proximity of some radio nodes, e.g., CSG cells, may be allowed. This allowance may be decided based on the complementary ranging information which may, e.g., comprise the ranging information for the nearby CSG nodes. In some example embodiments, the amount of configuration adaptation, e.g., the amount of power boosting or the amount of power reduction, may also be determined based on the complementary ranging information.

### Signalling Means for Obtaining the Complementary Positioning Information

The example embodiments comprise various methods for obtaining the complementary positioning information. Below a few examples of such methods are explained.

Obtaining the Complementary Positioning Information by an Explicit Request

The complementary positioning information may be explicitly requested, e.g., by the positioning node or any other node, e.g., SON, MDT, O&M node, gateway node or radio node. The request may be a part of the baseline method procedure or relate at least in part to the baseline method. The request may also relate to other positioning methods, e.g., E-CID or RF fingerprinting, than the baseline method. For example, a baseline method request may implicitly trigger an other method request, where the request may also be requesting a specific measurement. The other node (if not a positioning node but, e.g., a gateway node) may in turn also be requested by the positioning node. The request may be sent to a radio node, e.g., associated with the LCS target, or the LCS target or another node, e.g., a gateway node.

An example of the requested node may be a node performing at least one of the complementary measurements. Such a node may be a user equipment may be requested for a user equipment Rx-Tx measurement. The node may also be a base station may be requested for a base station Rx-Tx measurement or a TA measurement. The node performing the at least one complementary measurement may be a LMU or base station or user equipment may be requested for delay spread or Doppler information. The node may also be a LMU may be requested for TOA or TDOA measurement.

A requesting node may also be a node maintaining the related information and not performing the complementary measurement itself. An example of such a node may be a serving base station or a coordinating node, e.g., a master base station or a gateway node.

According to some of the example embodiments, the request may be sent prior performing measurements specific to the baseline method, e.g., prior sending the OTDOA assistance data, prior deciding the set of cooperating LMUs with UTDOA or in parallel with executing the baseline method to make the complementary positioning information available in the positioning node prior position calculation.

Depending on the requested node, the request may be sent via LPP or its extension such as LPPe or over extension, via LPPa or its extension or other similar protocol, e.g., between LMU and positioning node or between the LMU and the intermediate node, or via RRC. Upon receiving the request, the requested measurement is provided by the requested node, e.g., via LPP, LPPe, LPPa, its extensions, RRC or similar protocols, and may serve as the complementary measurement when used to enhance the baseline method.

Obtaining the Complementary Positioning Information in an Unsolicited Way

According to some of the example embodiments, complementary positioning information may be provided without an explicit request. The action may, however, be triggered by another positioning-related message, e.g., a request for certain measurements or a message initiating a certain positioning method. In another example, the complementary positioning information may be provided in a request for assistance data. According to some of the example embodiments, the complementary information may be provided together with the baseline measurements and/or in a request message when available.

The nodes that may provide this information may be any node performing at least one complementary measurement or any node maintaining the related information which may or may not be performing the complementary measurement itself, as described in the section above.

The complementary positioning information may also be deduced from the power class of the node, e.g., assuming that a low-power node typically has small coverage. For a positioning node, it is thus sufficient to know only the cell identification, e.g., from the LCS target, location register, or network node such as a MME, and the power class of the associated node, e.g., via operation and maintenance.

Extracting the Complementary Positioning Information from the Measurements of the Baseline Method

In one example, the complementary cell information may be reported for at least one cell with the baseline method measurements. For example, the information may be obtained from TDOA and TA of one of the two cells involved in the TDOA measurement. The range may also be estimated based on the transmission timing information and TOA measurement.

Signalling of the Complementary Positioning Information

In some example embodiments, the complementary measurement report may be signalled with any prior art signalling means, which may, however, require some changes in the behaviour of at least one of the reporting and receiving nodes. Such examples of changes which may be implemented are reporting a reference cell as a neighbour cell with a measurement, e.g., with an RSTD measurement with respect to the serving cell when the reference is not the serving cell or with TOA measurement instead of RSTD.

Another example change may be the ability to understand, e.g., according to a new behaviour or a pre-defined rule, that another measurement is transmitted instead of the baseline method measurement, e.g., TOA instead of TDOA. A further example of a change may be extracting the information from the received baseline measurement prior position calculation, as described in the previous section.

In some example embodiments, another measurement for at least some cells may be reported along with the native measurements of the baseline method. For example, with the currently standardized LPP, it is not possible to signal RSTD measurement (TDOA measurement for OTDOA) for the reference cell, which would become possible with the example embodiments presented herein.

In some, broader example embodiments, when the baseline method measurement, e.g., RSTD for OTDOA, is not available, undefined, or is not provided due to any other reason, covering signalling of the non-baseline method measurement, e.g., TOA measurement or other timing measurement such as Rx-Tx, TA, RTT, or any other measurement such as pathloss or RSRP, may be provided. The non-baseline method measurement may a pre-determined or an intermediate measurement of the baseline method measurement (such as TOA for RSTD). The type of the non-baseline measurement may also be dynamically decided and indicated when the measurement is provided. The type of the non-baseline measurement may also be configurable.

In some example embodiments, signalling may be enhanced by introducing new information elements for the complementary positioning information. New methods and procedures may also be introduced. This may concern LPP, LPPe, LPPa, their extensions, RRC, or other protocol.

Furthermore, according to some of the example embodiments the need for complementary positioning information may be indicated in a message transmitted to a node capable of delivering or triggering the delivery of this information. There may also be an indication for the availability of the complementary positioning information. There may also be a capability defined and indicated by signalling for a node to inform about whether the node is capable or not to manage and/or deliver the complementary positioning information.

The complementary measurement information may be provided in a measurement report or other message. Some examples of other messages may be a request for assistance data (see example 1 below), positioning-related capability information, etc. The cell for which the complementary measurement is provided may be a designated cell, e.g., indicated in a certain way or has a certain functionality, e.g., being serving or a reference cell. Furthermore, the complementary positioning information may be provided instead of a requested measurement native to the baseline method, e.g., when the requested measurement for the cell is not available or of a poor quality, or the cell was not included in the assistance data.

Examples of Signalling

Below various examples of signalling are provided according to some of the example embodiments presented herein.

### Example 1

Example 1 provides an example of an OTDOA request for assistance data. In sub-example (a), a OTDOA request for assistance data, according to 3GPP TS 36.355, is provided. It should be appreciated that the request of sub-example (a) does not contain any information other than the Cell ID.

Sub-example (b) provides an example enhancement of signalling according to some of the example embodiments. In sub-example (b), the bold type illustrates user equipment timing measurements (complementary data) which are provided in a message requesting assistance data for OTDOA positioning (the OTDOA method is the baseline method in this sub-example and the native measurement is only RSTD, and not UE Rx-Tx). One may also note that a measurement (UE Rx-Tx) is provided in a message may not be intended for OTDOA positioning use as is the case in the prior art.

Sub-example (c) provides an example enhancement of the signalling, e.g., from a user equipment, where the request is not related to a specific positioning method. According to some of the example embodiments, a measurement (UE Rx-Tx) is comprised in the message. This measurement is not used or included in measurements in the prior art.

Sub-example (d) provides another example of a signalling enhancement with user equipment speed and pathloss information. These are new measurements that currently may not be signalled with any positioning method, according to 3GPP TS 36.355, and the measurements are signalled in an assistance data request message.

(a):

```
OTDOA-RequestAssistanceData ::= SEQUENCE {
    physCellId INTEGER (0..503),
    ...
}
```

(b):

```
OTDOA-RequestAssistanceData ::= SEQUENCE {
    physCellId INTEGER (0..503),
    ueRxTx UeRxTx OPTIONAL,
    ...
}
CommonIEsRequestAssistanceData::= SEQUENCE {
    servingCellID ECGI OPTIONAL, -- Cond EUTRA
    ueRxTx UeRxTx OPTIONAL,
    ...
}
```

(d):

```
OTDOA-RequestAssistanceData ::= SEQUENCE {
    physCellId INTEGER (0..503),
    pathloss PATHLOSS OPTIONAL,
    speed SPEED OPTIONAL,
    ...
}
```

### Example 2

In the sub-examples of Example 2, complementary measurements are provided in a measurement report message, e.g, together with the baseline measurements.

In sub-example (a) a message according to 3GPP TS 36.355 is provided. Note that the message does not allow for signaling of the RSTD measurement or any other measurement indicative of the range for the reference cell.

In sub-example (b) an example enhancement of the signaling is provided. The range information is provided in the bold letting.

In sub-example (c) another example of signaling enhancement is provided. In the message pathloss information is illustrated as bold lettering.

(a):

```
-- ASN1START
OTDOA-SignalMeasurementInformation ::= SEQUENCE {
    systemFrameNumber BIT STRING (SIZE (10)),
    physCellIdRef INTEGER (0..503),
    cellGlobalIdRef ECGI OPTIONAL,
    earfcnRef ARFCN-ValueEUTRA OPTIONAL,
    referenceQuality OTDOA-MeasQuality OPTIONAL,
    neighbourMeasurementList NeighbourMeasurementList,
    ...
}
NeighbourMeasurementList ::= SEQUENCE (SIZE(1..24)) OF
NeighbourMeasurementElement
NeighbourMeasurementElement ::= SEQUENCE {
    physCellIdNeighbor INTEGER (0..503),
    cellGlobalIdNeighbour ECGI OPTIONAL,
    earfcnNeighbour ARFCN-ValueEUTRA OPTIONAL,
    rstd INTEGER (0..12711),
    rstd-Quality OTDOA-MeasQuality,
    ...
}
-- ASN1STOP
```

(b):

```
-- ASN1START
OTDOA-SignalMeasurementInformation ::= SEQUENCE {
    systemFrameNumber BIT STRING (SIZE (10)),
    physCellIdRef INTEGER (0..503),
    cellGlobalIdRef ECGI OPTIONAL,
    earfcnRef ARFCN-ValueEUTRA OPTIONAL,
    toa OTDOA-TOA OPTIONAL,
    referenceQuality OTDOA-MeasQuality OPTIONAL,
    neighbourMeasurementList NeighbourMeasurementList,
    ...
}
NeighbourMeasurementList ::= SEQUENCE (SIZE(1..24)) OF
NeighbourMeasurementElement
NeighbourMeasurementElement ::= SEQUENCE {
    physCellIdNeighbor INTEGER (0..503),
    cellGlobalIdNeighbour ECGI OPTIONAL,
    earfcnNeighbour ARFCN-ValueEUTRA OPTIONAL,
    rstd INTEGER (0..12711),
    rstd-Quality OTDOA-MeasQuality,
    ...
}
-- ASN1STOP
```

(c):

```
-- ASN1START
OTDOA-SignalMeasurementInformation ::= SEQUENCE {
    systemFrameNumber BIT STRING (SIZE (10)),
    physCellIdRef INTEGER (0..503),
    cellGlobalIdRef ECGI OPTIONAL,
    earfcnRef ARFCN-ValueEUTRA OPTIONAL,
    pathloss PATHLOSS OPTIONAL,
    referenceQuality OTDOA-MeasQuality OPTIONAL,
    neighbourMeasurementList NeighbourMeasurementList,
    ...
}
NeighbourMeasurementList ::= SEQUENCE (SIZE(1..24)) OF
NeighbourMeasurementElement
NeighbourMeasurementElement ::= SEQUENCE {
    physCellIdNeighbor INTEGER (0..503),
    cellGlobalIdNeighbour ECGI OPTIONAL,
    earfcnNeighbour ARFCN-ValueEUTRA OPTIONAL,
    rstd INTEGER (0..12711),
    rstd-Quality OTDOA-MeasQuality,
    ...
}
-- ASN1STOP
```

### Example 3

There is no prior art for LTE, since there is no signaling specified yet. An example of signaling, according to some of the example embodiments, may comprise an indication of the environment type (e.g. related to multipath and Doppler) by LMU to the positioning node, which may be exploited, e.g., when selecting cooperating LMUs. This example is provided below.

```
UTDOA-LMUInfo ::= SEQUENCE {
    EnvironmentIndicator ENVIRONMENT
    ...
}
```

### Example Node Configuration

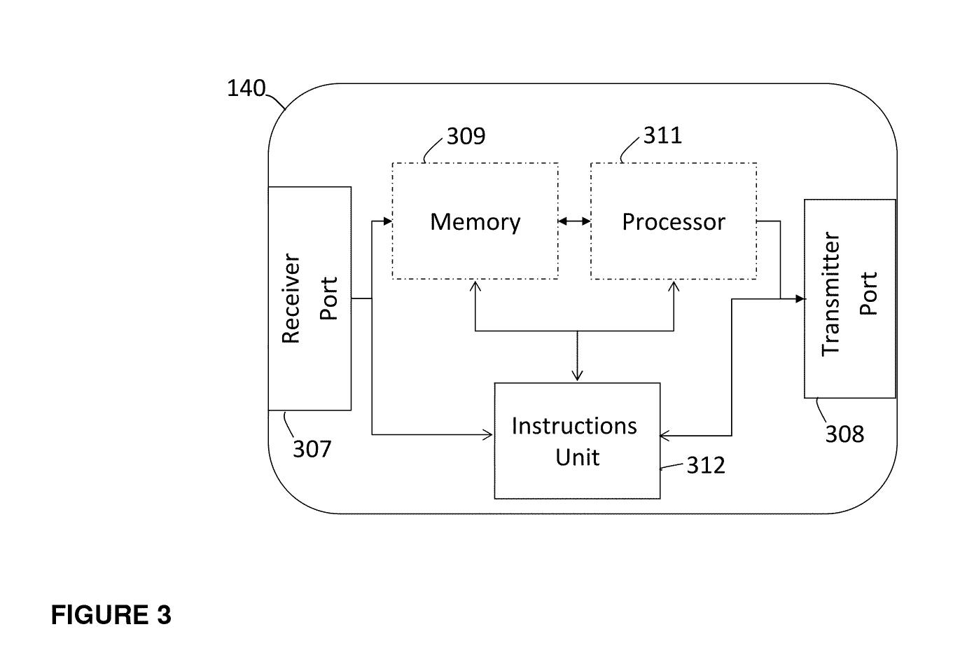

FIG. 3 illustrates an example of a positioning node 140 which may incorporate some of the example embodiments discussed above. According to some of the example embodiments, the positioning node 140 may be a Secure User Plane Location (SUPL) Location Centre (SLC) node 113a, an Enhanced Serving Mobile Location Centre (E-SMLC) node 119 and/or a SUPL Positioning Centre (SPC) node 113b.

As shown in FIG. 3, positioning node 140 comprises a receiver 307 and transmitter 308 ports configured to receive and transmit, respectively, any form of communications or control signals within a network. It should be appreciated that the receiver 307 and transmitter 308 ports may be comprised as a single transceiving unit or port. It should further be appreciated that the receiver 307 and transmitter 308 ports, or transceiving unit, may be in the form of any input/output communications port known in the art.

The positioning node 140 may further comprise at least one memory unit 309 that may be in communication with the receiver 307 and transmitter 308 ports. The memory unit 309 may be configured to store received or transmitted data and/or executable program instructions. The memory unit 309 may also be configured to complementary positioning information or measurement instructions of any kind. The memory unit 309 may be any suitable type of computer readable memory and may be of volatile and/or non-volatile type.

The positioning node 140 further comprises an instructions unit 312 which is configured to analyze, determine or alter measurement instructions based on the complementary positioning information. The node may further comprise a general processor 311.

The instructions unit 312 and/or the general processor 311 may be any suitable type of computation unit, e.g. a microprocessor, digital signal processor (DSP), field programmable gate array (FPGA), or application specific integrated circuit (ASIC), or any other type of processing circuitry. It should be appreciated that the instructions unit 312 and/or the general processor 311 may be comprised as a single unit or any number of units.

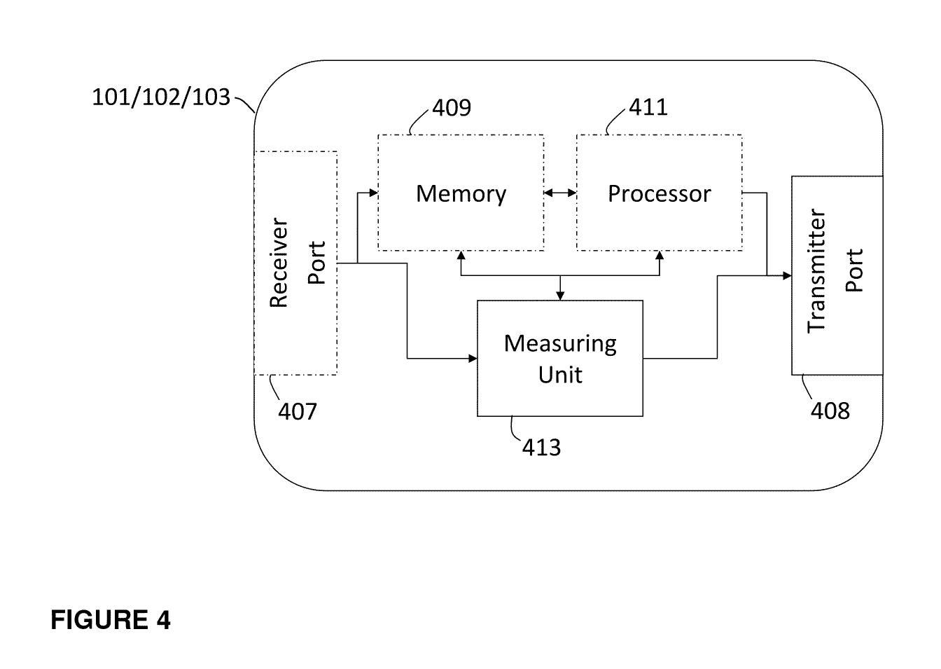

FIG. 4 illustrates an example of a radio node which may incorporate some of the example embodiments discussed above. According to some of the example embodiments, the radio node may be a base station 103, a Location Measurement Unit, LMU, node, or a user equipment 101.

As shown in FIG. 4, the radio node may comprise a receiver 407 and transmitter 408 ports configured to receive and transmit, respectively, any form of communications or control signals within a network. It should be appreciated that the receiver 407 and transmitter 408 ports may be comprised as a single transceiving unit or port. It should further be appreciated that the receiver 407 and transmitter 408 ports, or transceiving unit, may be in the form of any input/output communications port known in the art.

The radio node may further comprise at least one memory unit 409 that may be in communication with the receiver 407 and transmitter 408 ports. The memory unit 409 may be configured to store received or transmitted data and/or executable program instructions. The memory unit 409 may also be configured to complementary positioning information or measurement instructions of any kind. The memory unit 409 may be any suitable type of computer readable memory and may be of volatile and/or non-volatile type.

The radio node further comprises a measuring unit 413 which is configured to aid in the performance of positioning measurements. The node may further comprise a general processor 411.

The measuring unit 413 and/or the general processor 411 may be any suitable type of computation unit, e.g. a microprocessor, digital signal processor (DSP), field programmable gate array (FPGA), or application specific integrated circuit (ASIC), or any form of processing circuitry. It should be appreciated that the measuring unit 413 and/or the general processor 411 may be comprised as a single unit or any number of units.

### Example Node Operations

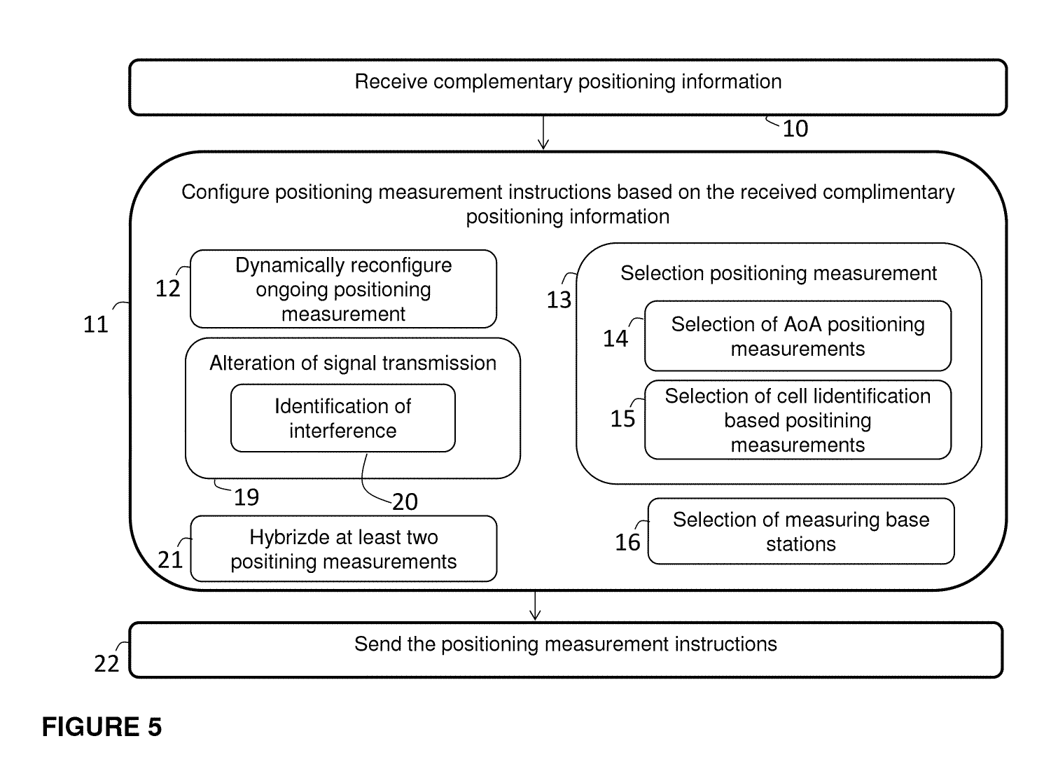

FIG. 5 is a flow diagram depicting example operational steps which may be taken by the positioning node of FIG. 3 in providing enhanced user equipment position determination management. It should be appreciated that the positioning node may be a Secure User Plane Location (SUPL) Location Center (SLC) node 113a, an Enhanced Serving Mobile Location Center (E-SMLC) node 119 and/or a SUPL Positioning Center (SPC) node 113b. In the example operations provided below a radio node is discussed. It should be appreciated that the radio node may be a base station 103, a LMU, and/or a user equipment 101.

Operation 10:

The positioning node 140 receives 10, from a radio node, complementary positioning information. The receiver port 307 is configured to perform the receiving 10.

It should be appreciated that the complementary information may be comprised in a measurement report message or a request message. It should also be appreciated that the complementary positioning information may be complementary ranging information comprising an estimate, measurement, or an indication related to a distance between at least one transmitter and a receiver, or a proximity to another node in the network. It should further be appreciated that the estimation or the measurement may be an absolute or a relative estimation or measurement. It should further be appreciated that the measurement may be a timing measurement received signal strength, or a pathloss measurement.

It should also be appreciated that complementary positioning information may be related to at least one of multipath, delay spread information, Doppler information and/or speed. In some example embodiments, the complementary positioning information may comprise environment type information, in such an instance the radio node may be a LMU node. It should further be appreciated that the complementary positioning information may be a time of arrival measurement signaled for a reference cell in a measurement report, in addition to non-reference cell measurements comprising time different of arrival with respect to the reference cell.

Operation 11:

The position node 140 configures 11 positioning measurement instructions based on the received complementary positioning information. The instructions unit 312 is configured to perform the configuring 11.

Example Operation 12:

According to some of the example embodiments, the configuring 11 may further comprise configuring or providing positioning measurement instructions for dynamically reconfiguring 12 an ongoing positioning measurement configuration. The instructions unit 312 may be configured to provide the instructions for the dynamic reconfiguration 12.

Example Operation 13:

According to some of the example embodiments, the configuring 11 may further comprise configuring or providing positioning measurement instructions for selecting or reselecting 13 a positioning measurement, or type of positioning measurement, to be performed. The instructions unit 312 may be configured to provide the instructions for selecting or reselecting 13.

Example Operation 14:

According to some of the example embodiments, the positioning measurement instructions for selecting or reselecting 13 may further comprise positioning measurement instructions for selecting 14 an angle of arrival (AoA) based positioning measurement when the complementary positioning information is a delay spread, and the delay spread is below a programmable threshold indicating a low multipath measurement environment. The instructions unit 312 may be configured to provide the instructions for selecting 14.

Example Operation 15:

According to some of the example embodiments, the positioning measurement instructions for selecting or reselecting 13 may further comprise positioning measurement instructions for selecting 15 a Cell Identification (CID), Enhanced Cell Identification (E-CID), and/or Adaptive Enhanced Cell Identification (AECID) positioning measurement when the complementary ranging information indicates a distance between a user equipment and a base station is within a programmable threshold. The instructions unit 312 may be configured to provide the instructions for the selecting 15.

Example Operation 16:

According to some of the example embodiments, the configuring 11 may further comprising configuring or providing positioning measurement instructions for selecting and/or deselecting 16 a radio node or a subset of radio nodes to be used in the positioning measurement based on the complementary positioning information. The instructions unit 312 may be configured to provide the instructions for the selecting and/or deselecting 16.

Example Operation 19:

According to some of the example embodiments, the configuring 11 may also comprise configuring or providing positioning measurement instructions for altering 19 a transmission of signals from the base station based on the commentary positioning information. The instructions unit 312 may be configured to provide instructions for the altering 19.

Example Operation 20:

According to some of the example embodiments, the instructions for altering 19 may further comprise instructions for identifying 20 periods of signal interference based on the complementary positioning information and providing instructions for severing cell signals to be muted, high power levels of the serving cell signals are transmitted during said periods of signal interference, and/or power boosting signals being transmitted from the base station based on the complementary ranging information. The instructions unit 312 may be configured to provide the instructions for the identifying 20.

Example Operation 21:

According to some of the example embodiments, the configuring 11 may also comprise configuring or providing positioning measurement instructions for hybridizing 21 at least two positioning measurements. The instructions unit 312 may be configured to provide the instructions for the hybridizing 21.

Operation 22:

The positioning node 140 sends 22, to the radio node, the positioning measurement instructions. The transmitter port 308 is configured to perform the sending 22.

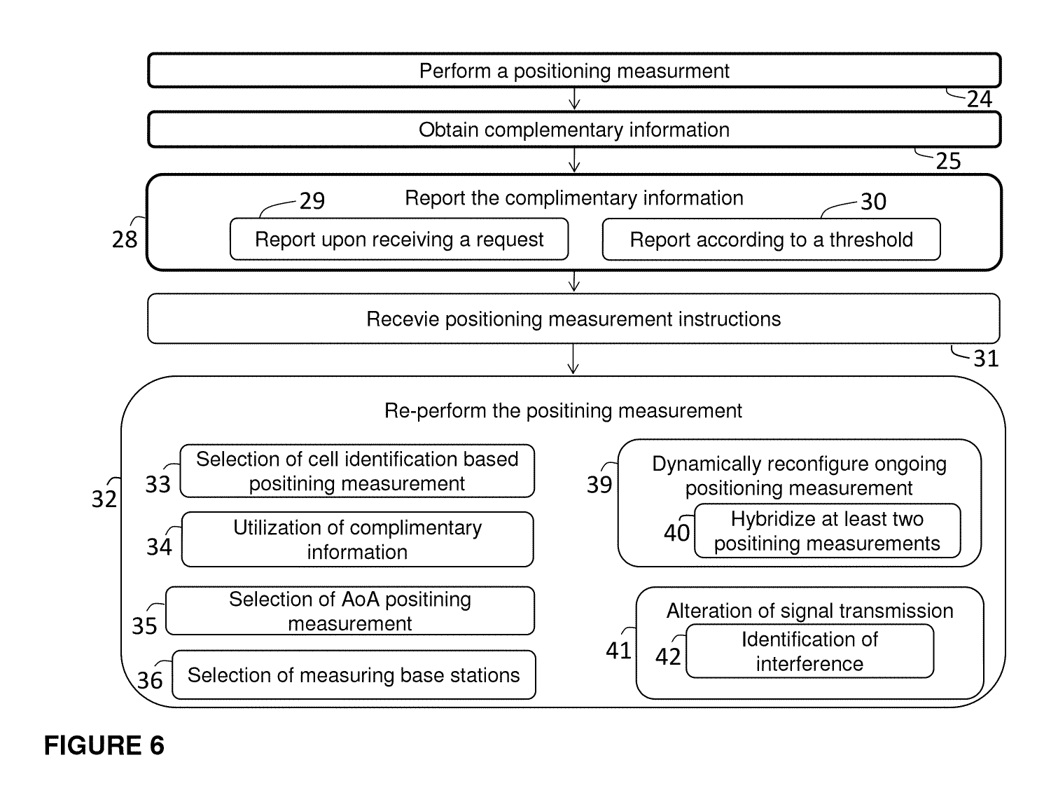

FIG. 6 is a flow diagram depicting example operational steps which may be taken by the radio node of FIG. 4 in providing enhanced position determination. It should be appreciated that the radio node may be a base station, user equipment, or a Location Measurement Unit (LMU). In some of the example operations a positioning node is discussed. The positioning node may be a Secure User Plane Location (SUPL) Location Center (SLC) node 113a, an Enhanced Serving Mobile Location Center (E-SMLC) node 119 and/or a SUPL Positioning Center (SPC) node 113b.

Operation 24:

The radio node performs 24 a positioning measurement. The measuring unit 413 is configured to perform 24 the position measurement.

Operation 25:

The radio node obtains 25 complementary positioning information based on the positioning measurement. The measuring unit 413 is configured to perform the obtaining 25.

It should be appreciated that the complementary information may be comprised in a measurement report message or a request message. It should also be appreciated that the complementary positioning information may be complementary ranging information comprising an estimate, measurement, or an indication related to a distance between at least one transmitter and a receiver, or a proximity to another node in the network. It should further be appreciated that the estimation or the measurement may be an absolute or a relative estimation or measurement. It should further be appreciated that the measurement may be a timing measurement received signal strength, or a pathloss measurement.

It should also be appreciated that complementary positioning information may be related to at least one of multipath, delay spread information, Doppler information and/or speed. In some example embodiments, the complementary positioning information may comprise environment type information, in such an instance the radio node may be a LMU node. It should further be appreciated that the complementary positioning information may be a time of arrival measurement signaled for a reference cell in a measurement report, in addition to non-reference cell measurements comprising time different of arrival with respect to the reference cell.

Operation 28:

The radio node reports 28 the complementary positioning information to a positioning node 140. The transmitter port 408 is configured to perform the reporting 28.

Example Operation 29:

According to some of the example embodiments, the reporting 28 may further comprise reporting 29 the complementary positioning information upon receiving a request from the positioning node 140. The transmitter port 408 may be configured to perform the reporting 29.

Example Operation 30:

According to some of the example embodiments, the reporting 28 may further comprise reporting 30 the complementary positioning information when an internal threshold has been passed. The internal threshold may be based on signaling and/or time metrics. The transmitter port 408 may be configured to perform the reporting 30.

Example Operation 31:

According to some of the example embodiments, the radio node receives 31, from the positioning node, positioning measurement instructions based on the complementary positioning information. The receiver port 407 is configured to perform the receiving 31.

Example Operation 32:

According to some of the example embodiments, the radio node re-performs 32 the positioning measurement based on the received positioning measurement instructions. The measurement unit 413 is configured to re-perform 32 the positioning measurement configuration based on the received instructions.

Example Operation 33:

According to some of the example embodiments, the re-performing 32 may further comprise selecting 33 a Cell Identification (CID), Enhanced Cell Identification (E-CID), and/or Adaptive Enhanced Cell Identification (AECID) positioning measurement when the complementary ranging information indicates the distance between the user equipment and a base station is within a programmable threshold. The measuring unit 413 may be configured to perform the selecting 33.

Example Operation 34:

According to some of the example embodiments, the re-performing 32 may further comprise utilizing 34 the complementary positioning information in an ongoing positioning measurement. The measuring unit 413 may be configured to perform the utilizing 34.

Example Operation 35:

According to some of the example embodiments, the re-performing 32 may further comprise selecting 35 an angle of arrival (AoA) based positioning measurement when the complementary positioning information is a delay spread, and the delay spread is below a programmable threshold indicating a low multipath measurement environment. The measurement unit 413 may be configured to perform the selecting 35.

Example Operation 36:

According to some of the example embodiments, the re-performing 32 may further comprise selecting and/or deselecting 36 a radio node or subset of radio nodes to be used in the positioning measurement based on the received instructions. The measurement unit 413 may be configured to perform the selecting and/or deselecting 36.

Example Operation 39:

According to some of the example embodiments, the re-performing 32 may further comprise dynamically reconfiguring 39 an ongoing positioning measurement according to the received positioning measurement instructions. The measurement unit 413 may be configured to perform the dynamic reconfiguration 39.

Example Operation 40:

According to some of the example embodiments, the dynamic reconfiguring 39 may further comprise hybridizing 40 at least to positioning measurements, or types of positioning measurements, to be performed. The measurement unit 413 may be configured to perform the hybridizing 40.

Example Operation 41:

According to some of the example embodiments, the re-performing 32 may further comprise altering 40 a transmission of signals from the base station based on the complementary positioning information. The measurement unit 413 may be configured to perform the altering 41.

Example Operation 42:

According to some of the example embodiments, the altering 41 may further comprise identifying 41 periods of signal interference based on the complementary positioning information and providing instructions for severing cell signals to be muted, high power levels of the serving cell signals are transmitted during said periods of signal interference, and/or power boosting signals being transmitted from the base station based on the complementary ranging information. The measurement unit 413 may be configured to perform the identifying 41.

### CONCLUSION

The embodiments described herein are not limited to a specific measurement, unless clearly stated. The signalling described in the example embodiments is either via direct links (protocols or physical channels) or logical links (e.g. via higher layer protocols and/or via one or more network nodes). For example, in LTE in the case of signalling between E-SMLC and LCS Client the positioning result may be transferred via multiple nodes (at least via MME and/or GMLC).

Although the description is mainly given for a user equipment, as measuring unit, it should be understood by the skilled in the art that “user equipment” is a non-limiting term which means any wireless device or node capable of receiving in DL and transmitting in UL (e.g. PDA, laptop, mobile, sensor, fixed relay, mobile relay or even a radio base station, e.g. femto base station). The example embodiments may apply for non-CA UE or both for user equipments capable and not capable of performing inter-frequency measurements without gaps, e.g. also including user equipments capable of carrier aggregation.

The positioning node 140 described in different embodiments is a node with positioning functionality. For example, for LTE it may be understood as a positioning platform in the user plane (e.g., SLP in LTE) or a positioning node in the control plane (e.g., E-SMLC in LTE). SLP may also consist of SLC and SPC, where SPC may also have a proprietary interface with E-SMLC. In a testing environment, at least positioning node may be simulated or emulated by test equipment.

A cell is associated with a radio node, where a radio node or radio network node or base station used interchangeably in the example embodiment description, comprises in a general sense any node transmitting radio signals used for measurements, e.g., base station, macro/micro/pico base station, home base station, relay, beacon device, or repeater. A radio node herein may comprise a radio node operating in one or more frequencies or frequency bands. It may be a radio node capable of CA. It may also be a single- or multi-RAT node. A multi-RAT node may comprise a node with co-located RATs or supporting multi-standard radio (MSR) or a mixed radio node.

Some positioning methods require measurements with multiple radio nodes, e.g., multiple radio nodes transmitting signals from distinct locations are necessary for OTDOA and multiple radio nodes receiving signals at distinct locations are necessary for UTDOA. Such radio nodes are referred herein as assisting nodes. The assisting nodes may or may not include the serving node.

A radio node herein may comprise a radio node operating in one or more frequencies or frequency bands. It may be a radio node capable of CA. It may also be a single- or multi-RAT node. A multi-RAT node may comprise a node with co-located RATs or supporting multi-standard radio (MSR) or a mixed radio node.

The example embodiments presented herein are not limited to LTE, but may apply in any RAN, single- or multi-RAT. Some other RAT examples are LTE-Advanced, UMTS, HSPA, GSM, cdma2000, HRPD, WiMAX, and WiFi. The foregoing description of the example embodiments have been presented for purposes of illustration and description.

The foregoing description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that any of the example embodiments presented herein may be used in conjunction, or in any combination, with one another.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

Some example embodiments may comprise a portable or non-portable telephone, media player, Personal Communications System (PCS) user equipment, Personal Data Assistant (PDA), laptop computer, palmtop receiver, camera, television, and/or any appliance that comprises a transducer designed to transmit and/or receive radio, television, microwave, telephone and/or radar signals.

The various example embodiments described herein are described in the general context of method steps or processes, which may be implemented in one aspect by a computer program product, embodied in a computer-readable medium, including computer-executable instructions, such as program code, and executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications may be made to these embodiments. Furthermore, it should be appreciated that the example embodiments presented herein may be used in any combination with one another. Accordingly, although specific terms are employed, they are used in a generic and descriptive sense only and not for purposes of limitation, the scope of the embodiments being defined by the following claims.

1. A method, in a positioning node, for enhanced user equipment positioning determination management, the positioning node being comprised in a communications network, the method comprising:
receiving, from a radio node, complementary positioning information;
configuring positioning measurement instructions based on the received complementary positioning information; and
sending, to the radio node, the positioning measurement instructions.

2. The method of claim 1, wherein the complementary positioning information is comprised in a measurement report message or a request message.

3. The method of claim 1, wherein the complementary positioning information is complementary ranging information comprising an estimate, measurement, or an indication related to a distance between at least one transmitter and a receiver, or a proximity to another node in the network.

4. The method of claim 1, wherein the complementary positioning information is a time of arrival measurement signalled for a reference cell in a measurement report, in addition to non-reference cell measurements comprising time difference of arrival with respect to the reference cell.

5. The method of claim 1, wherein the complementary positioning information is related to at least one of multipath, delay spread information, Doppler information and/or speed information.

6. The method of claim 1, wherein the configuring further comprises configuring the positioning measurement instructions for dynamically reconfiguring an ongoing positioning measurement.

7. The method of any claim 1, wherein the configuring further comprises selecting or reselecting a positioning measurement to be performed.

8. The method of claim 7, wherein the selecting or reselecting further comprises providing the positioning measurement instructions for selecting a Cell Identification, CID, Enhanced Cell Identification, E-CID, and/or an Adaptive Enhanced Cell Identification, AECID, positioning measurement when the complementary ranging information indicates a distance between a user equipment and a base station is within a programmable threshold.

9. The method of claim 7, wherein the selecting or reselecting further comprises providing the positioning measurement instructions for selecting an Angle of Arrival, AoA, based positioning measurement when the complementary positioning information is a delay spread, said delay spread being below a programmable threshold indicating a low multipath measurement environment.

10. The method of claim 1, wherein the configuring further comprises providing the positioning measurement instructions for selecting and/or deselecting a radio node or a subset of radio nodes to be used in the positioning measurement based on the complementary positioning information.

11. The method of claim 1, wherein the configuring further comprises providing the positioning measurement instructions for altering a transmission of signals from the base station based on the complementary positioning information.

12. The method of claim 11, wherein the positioning measurement instructions for altering further comprises identification instructions for identifying periods of signal interference based on the complementary positioning information and providing instructions for serving cell signals to be muted, high power levels of the serving cell signals to be transmitted during said periods of signal interference, and/or power boosting signals being transmitted from the base station based on complementary ranging information.

13. The method of claim 1, wherein the configuring further comprises hybridizing at least two positioning measurements.

14. A method, in a radio node, for enhanced position determination, the radio node being comprised in a communications network, the method comprising:
performing positioning measurement;
obtaining complementary positioning information based on the positioning measurement configuration; and
reporting the complementary positioning information to a positioning node.

15. The method of claim 14, further comprising:
receiving, from the positioning node, positioning measurement instructions based on the complementary positioning information; and
re-performing the positioning measurement based on the received positioning measurement instructions.

16. The method of claim 14, wherein the complementary positioning information is complementary ranging information comprising an estimate, measurement, or an indication related to a distance between at least one transmitter and a receiver, or a proximity to another node in the network.

17. The method of claim 16, wherein the estimate or the measurement is an absolute or a relative estimate or measurement.

18. The method of claim 14, wherein the measurement is a timing measurement, received signal strength or a pathloss measurement.

19. The method of claim 14, wherein the complementary positioning information is related to at least one of multipath, delay spread information, Doppler information and/or speed information.

20. The method of claim 14, wherein the complementary positioning information comprises environment type information and the radio node is a Location Measurement Unit, LMU, node.

21. The method of claim 14, wherein the complementary positioning information is a time of arrival measurement signalled for a reference cell in a measurement report, in addition to non-reference cell measurements comprising time difference of arrival with respect to the reference cell.

22. The method of claim 15, wherein the reporting further comprises reporting the complementary positioning information upon receiving a request from the positioning node.

23. The method of claim 15, wherein the reporting further comprises reporting the complementary positioning information when an internal threshold has been passed, said internal threshold being based on signalling and/or time metrics.

24. The method of claim 15, wherein the re-performing further comprises dynamically reconfiguring an ongoing position measurement according to the received positioning measurement instructions.

25. The method of claim 24, wherein the dynamically reconfiguring further comprises hybridizing at least two positioning measurement.

26. The method of any of claim 15, wherein the radio node is a user equipment or base station and the re-performing further comprises selecting a Cell Identification, CID, Enhanced Cell Identification, E-CID, and/or an Adaptive Enhanced Cell Identification, AECID, positioning measurement when the complementary ranging information indicates the distance between the user equipment and a base station is within a programmable threshold.

27. The method of claim 15, wherein the radio node is a base station or LMU and the re-performing further comprises selecting an Angle of Arrival, AoA, based positioning measurement when the complementary positioning information is a delay spread, said delay spread being below a programmable threshold indicating a low multipath measurement environment.

28. The method of claim 15, wherein the radio node is a user equipment or base station and the re-performing further comprises utilizing the complementary positioning information in an ongoing positioning measurement.

29. The method of claim 15, wherein the radio node is a base station and the re-performing further comprises altering a transmission of signals from the base station based on the complementary positioning information.

30. The method of claim 29, wherein the altering further comprises identifying periods of signal interference based on the complementary positioning information, where serving cell signals are muted, high power levels of the serving cell signals are transmitted during said periods of signal interference, and/or power boosting signals being transmitted from the base station based on complementary ranging information.

31. The method of claim 15, wherein the radio node is a user equipment or base station and the re-performing further comprises selecting and/or deselecting a radio node or a subset of radio nodes to be used in the positioning measurement based on the received instructions.

32. A positioning node for enhanced positioning determination management, the positioning node being comprised in a communications network, the node comprising:
a receiver port configured to receive, from a radio node, complementary positioning information;
an instructions unit configured to provide positioning measurement instructions based on the received complementary positioning information; and
a transmitter port configured to send the positioning measurement instructions to the radio node.

33. The positioning node of claim 32, wherein the positioning node is a Secure User Plane Location, SUPL, Location Centre, SLC, node, an Enhanced Serving Mobile Location Centre, E-SMLC, node and/or a SUPL Positioning Centre, SPC, node.

34. The positioning node of claim 32, wherein the radio network node is base station, a Location Measurement Unit, LMU, node, or a user equipment.

35. The positioning node of claim 32, wherein the complementary positioning information is comprised in a measurement report or a request message.

36. The positioning node of claim 32, wherein the complementary positioning information is complementary ranging information comprising an estimate, measurement, or an indication related to a distance between at least one transmitter and a receiver, or a proximity to another node in the network.

37. The positioning node of claim 32, wherein the complementary positioning information is related to at least one of multipath, delay spread information, Doppler information and/or speed information.

38. The positioning node of claim 32, wherein the complementary positioning information is a time of arrival measurement signalled for a reference cell in a measurement report, in addition to non-reference cell measurements comprising time different of arrival with respect to the reference cell.

39. The positioning node of claim 32, wherein the instructions unit is further configured to provide the positioning measurement instructions to dynamically reconfigure an ongoing positioning measurement.

40. The positioning node of claim 32, wherein the instructions unit is further configured to provide instructions for hybridizing at least two positioning measurements.

41. The positioning node of claim 32, wherein the instructions unit is further configured to provide instructions for selecting or reselecting a positioning measurement to be performed.

42. The positioning node of claim 41, wherein the instructions unit is further configured to provide instructions for selecting a Cell Identification, CID, Enhanced Cell Identification, E-CID, and/or an Adaptive Enhanced Cell Identification, AECID, positioning measurement when the complementary ranging information indicates the distance between a user equipment and a base station is within a programmable threshold.

43. The positioning node of claim 41, wherein the instructions unit is further configured to provide instructions for selecting an Angle of Arrival, AoA, based positioning measurement when the complementary positioning information is a delay spread, said delay spread being below a programmable threshold indicating a low multipath measurement environment.

44. The positioning node of claim 32 wherein the instructions unit is further configured to provide instructions for utilizing the complementary positioning information in the ongoing positioning measurement.

45. The positioning node of claim 32, wherein the instructions unit is further configured to provide instructions for selecting and/or deselecting a radio node or a subset of radio nodes to be used in the positioning measurement based on the complementary positioning information.

46. The positioning node of claim 32, wherein the instructions unit is further configured to provide instructions for altering a transmission of signals from the base station based on the complementary positioning information.

47. The positioning node of claim 46, wherein the instructions for altering further comprise instructions for identifying periods of signal interference based on the complementary positioning information and providing instructions for serving cell signals to be muted, high power levels of the serving cell signals to be transmitted during said periods of signal interference, and/or power boosting signals being transmitted from the base station based on complementary ranging information.

48. A radio node, for enhanced position determination, the radio node being comprised in a communications network, the radio node comprising:
a measuring unit configured to perform a positioning measurement and obtain complementary positioning information based on the positioning measurement; and
a transmitter port configured to send the complementary positioning information to a positioning node.

49. The radio node of claim 48, further comprising:
a receiver port configured to receive positioning measurement instructions, from the positioning node based on the complementary positioning information; and
the measuring unit further configured to re-perform the positioning measurement based on the received positioning measurement instructions.

50. The radio node of claim 48, wherein the radio node is a base station, a Location Measurement Unit, LMU, node, or a user equipment.

51. The radio node of claim 48, wherein the positioning node is a Secure User Plane Location, SUPL, Location Centre, SLC, node, an Enhanced Serving Mobile Location Centre, E-SMLC, node and/or a SUPL Positioning Centre, SPC, node.

52. The radio node of claim 48, wherein the complementary positioning information is complementary ranging information comprising an estimate, measurement, or an indication related to a distance between at least one transmitter and a receiver, or a proximity to another node in the network.

53. The radio node of claim 52, wherein the estimate or the measurement is an absolute or a relative estimation or measurement.

54. The radio node of claim 48, wherein the measurement is a timing measurement, received signal strength or a pathloss measurement.

55. The radio node of claim 48, wherein the complementary positioning information is related to at least one of multipath, delay spread information, Doppler information and/or speed information.

56. The radio node of claim 48, wherein the complementary positioning information comprises environment type information and the radio node is a Location Measurement Unit, LMU, node.

57. The radio node of claim 48, wherein the complementary positioning information is a time of arrival measurement signalled for a reference cell in a measurement report, in addition to non-reference cell measurements comprising time difference of arrival with respect to the reference cell.

58. The radio node of any claim 48, wherein the transmitter port is further configured to send the complementary positioning information upon receiving a request from the positioning node.

59. The radio node of claim 48, the transmitter port is further configured to send the complementary positioning information when an internal threshold has been passed, said internal threshold being based on signalling and/or time metrics.

60. The radio node of claim 49 wherein the measuring unit is further configured to dynamically reconfigure an ongoing positioning measurement based on the received positioning measurement instructions.

61. The radio node of claim 49, wherein the radio node is a user equipment and the measuring unit is further configured to select one of a Cell Identification, CID, Enhanced Cell Identification, E-CID, and/or an Adaptive Enhanced Cell Identification, AECID, positioning measurement when the complementary ranging information indicates the distance between the user equipment and a base station is within a programmable threshold.

62. The radio node of claim 49, wherein the radio node is a base station and the measuring unit is further configured to select an Angle of Arrival, AoA, based positioning measurement when the complementary positioning information is a delay spread, said delay spread being below a programmable threshold indicating a low multipath measurement environment.

63. The radio node of claim 49, wherein the radio node is a user equipment and the measuring unit is further configured to utilize the complementary positioning information in the ongoing positioning measurement.

64. The radio node of claim 49, wherein the radio node is a base station and the measuring unit is further configured to alter a transmission of signals from the base station based on the complementary positioning information.

65. The radio node of claim 64, wherein the measuring unit is further configured to identify periods of signal interference based on the complementary positioning information, where serving cell signals are muted, high power levels of the serving cell signals are transmitted during said periods of signal interference, and/or power boosting signals being transmitted from the base station based on complementary ranging information.

66. The radio node of claim 49, wherein the radio node is a user equipment and the measuring unit is further configured to select and/or deselect a radio node or a subset of radio nodes to be used in the positioning measurement based on the received instructions.
